(19) United States
(12) Patent Application Publication
(10) Pub. No.: US 2011/0060734 A1
(43) Pub. Date: Mar. 10, 2011

(54) Method and Apparatus of Knowledge Base Building

(75) Inventors: Lei Hou, Hangzhou (CN); Jisheng Qin, Hangzhou (CN); Wei Chen, Hangzhou (CN); Qin Zhang, Hangzhou (CN)

(73) Assignee: ALIBABA GROUP HOLDING LIMITED, Grand Cayman (unknown)

(21) Appl. No.: 12/863,683

(22) PCT Filed: Apr. 27, 2010
(86) PCT No.: PCT/US10/32581

§ 371 Date: Jul. 20, 2010

(30) Foreign Application Priority Data
Apr. 29, 2009 (CN) 200910136206.6

(51) Int. Cl. G06F 17/30

(52) U.S. Cl. 707/723; 707/776; 707/E17.108

(57) ABSTRACT

The present disclosure provides a method and apparatus of knowledge base building to automatically construct a knowledge base. Furthermore, the disclosed techniques can be used to improve the accuracy of that knowledge base. In one aspect, a method acquires a sentence from a webpage using a basic data processing layer of a computing apparatus. The acquired sentence is parsed into words using a data mining layer of the computing apparatus. One or more representative words in a first category of a knowledge base are matched with the words parsed from the acquired sentence. When there is a match between one of the representative words and one of the words parsed from the acquired sentence, a string of words adjacent the matched word in the acquired sentence is added to the first category as a first entry. When matching the words parsed from the acquired sentence with a second entry of a second category of the knowledge base, it is determined whether or not an established correlation exists between the first category and the second category. When it is determined that an established correlation exists between the first category and the second category, a correlation between the first entry of the first category and the second entry of the second category is established. The present disclosure also discloses methods for searching information and computing apparatuses that implement the methods.

### RELATED APPLICATIONS

This application is a national stage application of an international patent application PCT/US10/32581, filed Apr. 27, 2010, which claims priority benefit of Chinese patent application No. 200910136206.6, filed Apr. 29, 2009, entitled “METHOD AND APPARATUS OF KNOWLEDGE BASE BUILDING”, which applications are hereby incorporated in their entirety by reference.

### TECHNICAL FIELD

The present disclosure relates to the field of computer and communications and, more particularly, to the method and apparatus for building a knowledge base.

### BACKGROUND

With computer and network related technologies being widely used, sharing of resources is a main feature. Among many uers, how to search for information they are looking for from all the available sources of information is a common concern. Accordingly, various search techniques have been developed.

One of the major search techniques is keyword search. A user inputs one or more keywords as a search term, and a search engine conducts a search based on the search term to identify web pages that contain the search term. However, often times a word may have multiple meanings, and a word in different industries or different fields may also have a variety of interpretations or applications. As not all of the possible meanings of a word are relevant to a user, web pages turned up in a search based on irrelevant meanings may be useless to the user. The existence of websites such as How-net seem to partially addresses such a problem.

With How-net, one word or phrase contains multiple concepts, and multiple searches are conducted based on each of the multiple concepts. The results of such searches tend to be more accurate.

However, existing How-net is established and organized manually, and thus tends to cover only high-frequency (most common) content. It thus has limited coverage of the network. Furthermore, with fast development of the web, the speed at which the amount of information available on the web far exceeds the speed of the manual update of How-net. Consequently, the search results using How-net also tend to be less than optimal.

### SUMMARY OF THE DISCLOSURE

The present disclosure provides exemplary implementations of a method and apparatus for building a knowledge base. The method and apparatus can be used to implement an automatic generation of a knowledge base and improve the accuracy of such a knowledge base.

In one aspect, a method acquires a sentence from a webpage using a basic data processing layer of the computing apparatus. The acquired sentence is parsed into words using a data mining layer of the computing apparatus. One or more representative words in a first category of a knowledge base are matched with the words parsed from the acquired sentence. When there is a match between one of the representative words and one of the words parsed from the acquired sentence, a string of words adjacent the matched word in the acquired sentence is added to the first category as a first entry. When matching the words parsed from the acquired sentence with a second entry of a second category of the knowledge base, it is determined whether or not an established correlation exists between the first category and the second category. When it is determined that an established correlation exists between the first category and the second category, a correlation between the first entry of the first category and the second entry of the second category is established.

Acquiring a sentence from a webpage may comprise dividing the acquired sentence into multiple shorter sentences based on punctuation marks in the acquired sentence. Further, parsing the acquired sentence may comprise parsing the acquired sentece or parsing the multiple shorter sentences.

The method may further count a number of appearances of individual sentences using the basic data processing layer, and establish, using the data mining layer, a weighted value of the first entry of the first category based on a number of appearances of any sentence having the first entry and one or more of the representative words adjacent the first entry.

The data mining layer may employ a parsing system that includes the one or more representative words to divide the acquired sentence.

The knowledge base may include a common word system and a substantive word system. The common word system and the substantive word system may respectively include different categories. The representative words may include category-corresponding index words of the substantive word system and category-corresponding seed words of the common word system. When the string of words adjacent the matched word in the acquired sentence is added to the first category as the first entry, the string of words may be added to the common word system or the substantive word system that includes the first category. When the first category is one of the categories included in the common word system, the first entry may be set as the seed word corresponding to the first category.

Establishing a correlation between the first entry of the first category and the second entry of the second category may comprise obtaining a frequency of appearance of sentences having the first entry and the second entry, and establishing the correlation between the first and second entry when the frequency of appearance of sentences having the first entry and the second entry exceeds a predetermined threshold value.

The data mining layer may generate a respective result file according to each category and entries under each category. An integration layer of the computing apparatus may integrate multiple result files into a single result file. A number of appearances of individual sentences is counted. A weighted value of the first entry of the first category may be established based on a number of appearances of any sentence having one or more of the representative words and the first entry. The weighted values of individual entries under different categories may be compared. Entry-corresponding categories may be filtered.

The method may further acquire a table from the webpage, and attribute a word that appears in the table in a pair with the first entry multiple times as a property of the first entry.

Acquiring a sentence from a webpage may comprise acquiring a sentence that contains special symbols from the webpage.

In another aspect, a method of information searching includes: identifying a label based on one or more keywords in a webpage and entries related to the one or more keywords in a knowledge base, the label matching a search term inputted by a user; locating the webpage that corresponds to the label; and providing to the user the webpage or a link to the webpage.

The knowledge base may be constructed by: acquiring a sentence from a webpage using a basic data processing layer of the computing apparatus; parsing the acquired sentence into words using a data mining layer of the computing apparatus; matching one or more representative words in a first category of a knowledge base with the words parsed from the acquired sentence; when there is a match between one of the representative words and one of the words parsed from the acquired sentence, adding a string of words adjacent the matched word in the acquired sentence to the first category as a first entry; when matching the words parsed from the acquired sentence with a second entry of a second category of the knowledge base, determining whether or not an established correlation exists between the first category and the second category; and when it is determined that an established correlation exists between the first category and the second category, establishing a correlation between the first entry of the first category and the second entry of the second category.

In still another aspect, a method of information searching includes: parsing a search term inputted by a user using entries of a knowledge base; matching words parsed from the search term with the entries of the knowledge base; identifying those entries of the knowledge base that are related to an entry having a match with a word parsed from the search term; updating the search term with those entries of the knowledge base that are related to the entry having a match with a word parsed from the search term; and conducting a search based on the updated search term.

The knowledge base may be constructed by: acquiring a sentence from a webpage using a basic data processing layer of the computing apparatus; parsing the acquired sentence into words using a data mining layer of the computing apparatus; matching one or more representative words in a first category of a knowledge base with the words parsed from the acquired sentence; when there is a match between one of the representative words and one of the words parsed from the acquired sentence, adding a string of words adjacent the matched word in the acquired sentence to the first category as a first entry; when matching the words parsed from the acquired sentence with a second entry of a second category of the knowledge base, determining whether or not an established correlation exists between the first category and the second category; and when it is determined that an established correlation exists between the first category and the second category, establishing a correlation between the first entry of the first category and the second entry of the second category.

In one aspect, a computing apparatus that constructs a knowledge base includes: a basic data processing module that acquires one or more sentences from a webpage; and a data mining module that parses the one or more sentences acquired from the webpage. The data mining module further: matches one or more representative words in a first category of a knowledge base with the words parsed from the acquired sentence; when there is a match between one of the representative words and one of the words parsed from the acquired sentence, adds a string of words adjacent the matched word in the acquired sentence to the first category as a first entry; when matching the words parsed from the acquired sentence with a second entry of a second category of the knowledge base, determines whether or not an established correlation exists between the first category and the second category; and when it is determined that an established correlation exists between the first category and the second category, establishes a correlation between the first entry of the first category and the second entry of the second category.

In one aspect, a search engine includes: a first query module that identifies a label corresponding to search term inputted by a user; a second query module that identifies a webpage corresponding to the label; an interface module that provides to the user the webpage or a link to the webpage; and a label generation module that generates labels corresponding to the webpage based on one or more keywords of the webpage and entries of a knowledge base that are related to the one or more keywords.

In another aspect, a search engine includes: a parsing module that parses a search term inputted by a user based on entries of a knowledge base; a matching module that matches words parsed from the search term with the entries of the knowledge base; a query module that identifies those entries of the knowledge base that are related to an entry having a match with a word parsed from the search term; an update module that updates the search term with those entries of the knowledge base that are related to the entry having a match with a word parsed from the search term; and a search module that conducts a search based on the updated search term.

### DESCRIPTION OF DRAWINGS

FIG. 1A shows a diagram of a computing apparatus according to an embodiment of the present disclosure.

FIG. 1B shows a diagram of a network system according to an embodiment of the present disclosure.

FIG. 1C shows a flowchart of creating a knowledge base according to an embodiment of the present disclosure.

FIG. 2 shows a flowchart of creating a knowledge base according to another embodiment of the present disclosure.

FIG. 3 shows a flowchart of searching information when analyzing a webpage's schema according to an embodiment of the present disclosure.

FIG. 4 shows a flowchart of searching information when analyzing a user's intent according to an embodiment of the present disclosure.

FIG. 5 show a diagram of a computing apparatus according to another embodiment of the present disclosure.

FIG. 6 shows a block diagram of a search engine according to an embodiment of the present disclosure.

FIG. 7 shows a block diagram of a search engine according to another embodiment of the present disclosure.

### DETAILED DESCRIPTION

The present disclosure describes techniques that analyze words that appeared on a webpage. Words in a sentence from the webpage and to be added to a category in a knowledge base are regarded as the entry under that category. Based on correlations between categories, correlations between entries that show up in pairs are also established. This enables automatic construction of a knowledge base and thus avoids the need of manual resources in the process.

In one embodiment, a knowledge base includes one or more categories. Each category has respective corresponding entries and representative words. One entry may correspond to one or more categories, and may have different weights for different categories. An entry can also have a corresponding property. Furthermore, correlations may be established between categories and between entries. For example, a category of “product” may have a corresponding entry of “mobile phone” and representative words such as “sale,” “model,” “brand,” and “functionality.” The entry “mobile phone” may have properties such as functionality, size, battery type, etc. In one embodiment, categories, representative words corresponding to each category, and correlations between categories are preset in the knowledge base. As the knowledge base grows, entries, correlations between entries and properties of entries will be added.

TABLE 1
Example of correlation between entries and categories

| | Total Weight (sum | Corresponding Categories |
|---|---|---|
| | of weights in all | (respective weight of the |
| Entry | categories) | entry in this category) |
| Apple | 340,000 | Fruits (100,000), |
| | | laptop computers (100,000), |
| | | cell phones (100,000), |
| | | apparels (40,000) |
| . . . | . . . | . . . |

TABLE 2
Example of an entry and its corresponding properties

| Entry | Properties |
|---|---|
| Cell phone | Size |
| | Battery Type |

TABLE 3
Example of correlation between entries

| Entry | Related Entry |
|---|---|
| Cell phone | Nokia |
| | . . . |

TABLE 4
Example of correlation between categories

| Category | Related Category |
|---|---|
| Product | Brand |
| | . . . |

TABLE 5
Example of a category and its corresponding representative words

| Category | Representative Words |
|---|---|
| Product | Sale |
| | . . . |

In addition to “sale” as shown in Table 5, other representative words that may correspond to the category “product” include, for example, “model”, “brand”, etc. As another example, the category “film and television” may include representative words such as “director”, “lead actor”, “lead actress”, “release”, etc. In one embodiment, representative words for each category are preset, or predetermined, based on the characteristics of the respective category.

In one embodiment, text documents, tables, database or other suitable means may be used to store the data of Tables 1-5. It is to be understood that Tables 1-5 are provided as examples, and may be combined in different ways without altering the correlations.

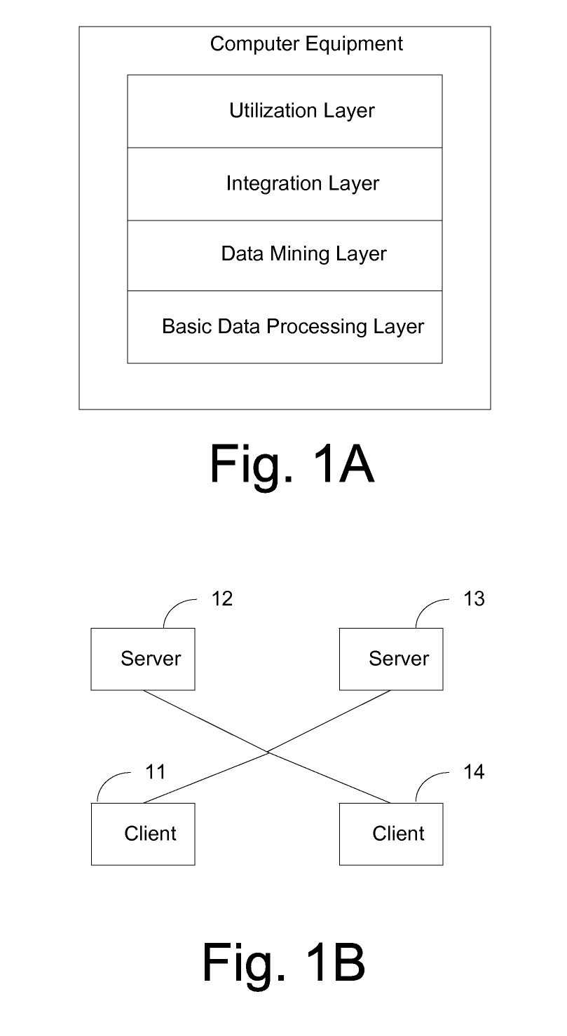

As shown in FIG. 1A, in one embodiment, a computing apparatus that constructs the disclosed knowledge base may include a basic data processing layer, a data mining layer, an integration layer, and a utilization layer. Alternatively, these functional layers may be implemented in different computing apparatuses. These different computing apparatuses may be servers and/or client terminal apparatuses, and can form a network as shown in FIG. 1B. For example, the basic data processing layer may be implemented in client 11, the data mining layer may be implemented in server 12, the integration layer may be implemented in server 12 or server 13, and the utilization layer may be implemented in client 14. In other embodiments, there may be other servers and clients in additional to the client 11, server 12, server 13, and client 14.

The basic data processing layer acquires sentences from a webpage. The acquired sentences may be sentences from the content of the webpage. The data mining layer parses each of the acquired sentences into words, and matches the representative words of a category, e.g., a first category, in the knowledge base with the words parsed from a sentence. When there is a successful match between a representative word and a word parsed from a sentence, a string of words and/or symbols adjacent the matched word parsed from the sentence is added to a first category as a first entry. When a word parsed from the sentence is matched with a second entry of a second category of the knowledge base, a determination is made as to whether or not a correlation has been established between the first category and the second category. In the event that a correlation exists between the first and second categories, a correlation is established between the first entry of the first category and the second entry of the second category. That is, the second entry of the second category may be added as a corresponding entry of the first entry of the first category. Likewise, the first entry of the first category may be added as a corresponding entry of the second entry of the second category. Those skilled in the art will appreciate that the first and second categories described above may be any two categories. For the sake of convenience and in order to distinguish the two categories, they are referred to as the first and second categories. Similarly, the first and second entries may be any two entries.

A computing apparatus may also include an integration layer and utilization layer as shown in FIG. 1A. The Integration layer integrates the result files for various categories, as produced by the data mining layer, into a single result file. The utilization layer enables utilization of the data.

For illustration purpose and as an example, the data mining layer produces the following result files for category 1, category 2, and category 3:

| | | |
|---|---|---|
| Result file 1 | Result file 2 | Result file 3 |
| Category 1 | Category 2 | Category 3 |

| | | | | | |
|---|---|---|---|---|---|
| Entry 1 | 100 | Entry 1 | 50 | Entry 1 | 80 |
| Entry 2 | 50 | Entry 2 | 100 | Entry 2 | 8 |
| | | Entry 3 | 80 | Entry 3 | 100 |

The integration layer integrates these three result files into a single result file, as shown in Table 6 below.

TABLE 6
Example of a result file after integration

| | Category | | |
|---|---|---|---|
| | Category 1 | Category 2 | Category 3 |
| Entry | Weight | | |
| Entry 1 | 100 | 50 | 80 |
| Entry 2 | 50 | 100 | 8 |
| Entry 3 | 0 | 80 | 100 |

In Table 6, a “0” indicates there is no correlation between the entry and the category.

FIG. 1C illustrates a general process 100 of constructing a knowledge base according to one embodiment, which includes the following steps:

At 101, a basic data processing layer in a computing apparatus acquires a sentence from a webpage.

At 102, a data mining layer of the computing apparatus parses, or segments, the sentence.

At 103, the data mining layer matches representative words corresponding to a first category of a knowledge base with words parsed from the sentence.

At the start of construction of the knowledge base, categories, and representative words corresponding to each category, need to be defined and established. As the construction of the knowledge base continues, the representative words will be updated as new entries are added to the knowledge base.

At 104, when there is a successful match between a representative word and a word parsed from a sentence, the data mining layer adds a string of words and/or symbols adjacent the matched word in the sentence to the first category as a first entry.

At 105, when a word parsed from the sentence is matched with a second entry of a second category of the knowledge base, the data mining layer determines whether or not a correlation has been established between the first category and the second category. In the event that a correlation exists between the first and second categories, the data mining layer establishes a correlation between the first entry of the first category and the second entry of the second category.

The process described herein for building a knowledge base may be used for updating the knowledge base, and may be repeated periodically.

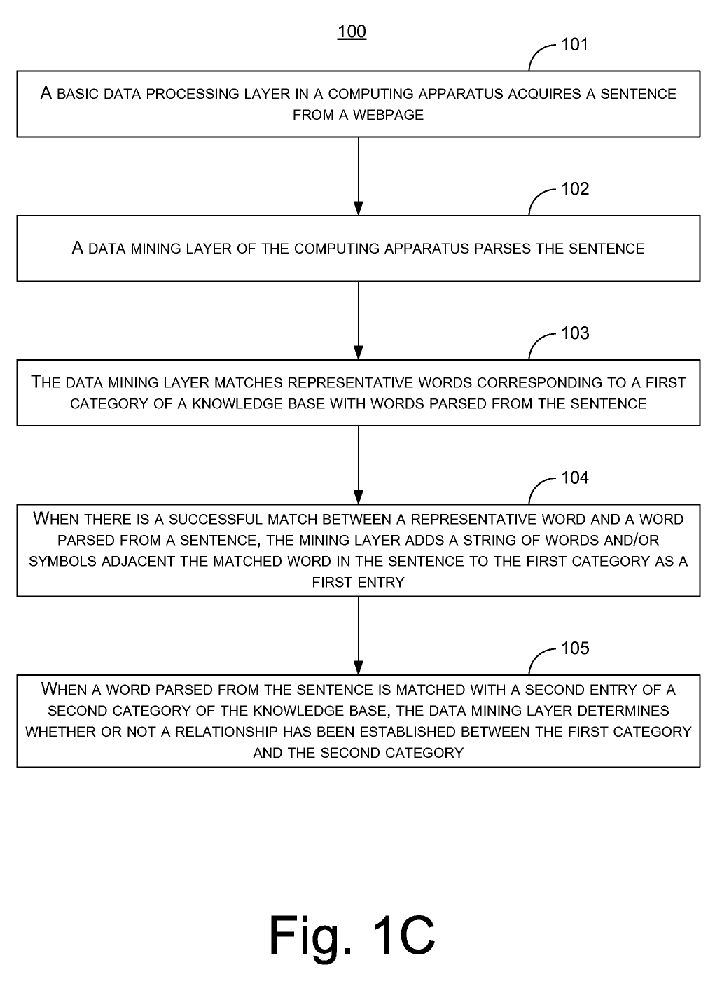

FIG. 2 illustrates a detailed process 200 of constructing a knowledge base according to one embodiment, which includes the following steps:

At 201, the data processing layer acquires sentences from a webpage. In particular, the data processing layer acquires simple sentences and phrases, and the frequency of the appearance of the sentence, i.e., the frequency of the same sentence on the webpage. The text message on the webpage can be stored and collected in advance afterwards, according to the punctation marks in the sentence obtained from text message.

A sentence can be a simple sentence, a phrase, or a long sentence. A simple sentence refers to a sentence in front of a period, question mark, or exclamation point, with no other punctuation marks in between words of the sentence. A phrase refers to the use of a comma or a semicolon at the end, with no other punctuation marks between words of the phrasse. A long sentence refers to a sentence in front of a period, question mark, or exclamation point, with one or more commas or semicolons in between. If a long sentence is being searched, it is divided into many short phrases according to the puntuation marks. As the sentence gets longer and the content gets more complex, it will be divided into many phrases in order to analyze it easier, thus yielding more more accurate results. For example, the sentence being searched may be [symbol] AA [symbol] BB1

[symbol]

At 202: The data mining layer parses an acquired sentence using a parsing system. For example, the sentence [symbol] AA [symbol] BB1 [symbol] becomes “ [symbol] AA, [symbol] BB1, [symbol] after parsing. Words corresponding to this category can be added into the parsing system, which is used to segment sentences.

It is not easy to complete the parsing, or segmentation. For example, the term [symbol] may not be easily parsed when using a conventional parsing system, which tends to include only a small basic glossary. Usually, a conventional parsing system does not have the most recent foreign words or transliteration. When the conventional parsing system has no way of matching the words, it will use individual characters of the unknow words as units of division. Thus, the term [symbol] can be parsed as [symbol] [symbol] If the term [symbol] is added to the parsing system , then the term [symbol] [symbol] can be successfully matched. Accordingly, the term [symbol] is parsed a one complete word.

At 203: The data mining layer will match the representative words of the first category with a parsed word. When a representative word and a word parsed from a sentence is matched consistently, the match is considered successful with this sentence and the successfully matched word is retained. For the first category, unmatched sentences are dropped. Unmatched sentences can be recycled for matching with other categories' representative words.

At 204: The mining layer decides whether the successful matches have unkown words that are not yet included in the knowledge base. If (continuing on step 205 described below) otherwise, at the end of the sentence the process 200 can still continue to decide whether other successful matches have unkown words that are not yet included in the knowledge base. If the unknown word is not included, the process 200 can still match the representative words of the other categories with the words obtained after parsing them from the respective sentence. Then Step 203 is repeated.

At 205: The mining layer will regard the unknown string of words and/or marks adjacent the successfully matched words in the sentence as a first entry added to the first layer. A string may include a number of unknown words. For example, a sentence for the phrase [symbol] [symbol] (English translation: “the new movie Curse of the Golden Flower”) is parsed into individual characters or terms as in [symbol] [symbol] [symbol] to be matched with the representative words, where [symbol] [symbol] are unknown words. The phrase [symbol] [symbol] is considered as the unknown string adjacent the word [symbol] which is treated as an independent and complete word.

At 206, the data mining layer will add the first entry to the parsing system to update the parsing system. The updated parsing system will not easily parse words. For example, when encountering the phrase [symbol] [symbol] again, the parsing system will treat the phrase as one word, [symbol] [symbol] and not parse it into, for example,

[symbol]

[symbol]

[symbol]

At 207, the data mining layer provides the first entry's weight in the first category based on the frequency of appearance of the first entry and adjacent representative words in the sentence they are located in. For example, on counting the frequency of appearance of the acquired sentence, the number of times the first entry BB1 and the representative word [symbol] appear in sentence 1 is 1000. The number of times they appear in sentence 2 is 100; and in sentence 3, the number of appearances is 10. Thus, the weight is f(1000)+f(100)+f(10). Each of these is the frequency of appearance in the respective sentence as a function of weight, such as base 10 logarithmic functions for example.

At 208, the data mining layer acquires the appearance frequency of the first entry of the first category and the second entry of the second category in the sentences. Accordingly, a correlation between the first category and the second category is established.

At 209, when this frequency exceeds a default correlation threshold, the data mining layer establishes a relation between the first entry and the second entry. In one embodiment, step 208 can be repeated to establish more correlations for the first entry. Through the correlation threshold, the process 200 can filter out errors in correlations due to clerical mistakes. For example, with a correlation between the category “model” and the category “brand” established previously, the correlation between “BB1” and “AA” can be established.

In one embodiment, the steps 206, 207 and 208 are three separate processes and have no strict successive implementation, and can also be implemented at the same time.

In one embodiment, a knowledge base includes a common word system and a substantive word system. The words included in the substantive word system correspond to index words and the words included in the common word system correspond to seed words. The entries included in the common word system are mostly routine words that do not change often such as names of places. The entries included in the substantive word system are words that are more frequently updated, such as personal name and movie name. The difference between the common word system and substantive word system depends on the categories included in each system. The index words in the substantive word system are not included in the entries under the corresponding category. The seed words in the common word system belong to the entries under the corresponding categories. The categories under the common word system and substantive word system can use different update cycles. The update cycle of the common word system can be longer than that of the substantive word system.

Tables 7 and 8 respectively show sample common word system and sample substantive word system.

TABLE 7
Example of Common Word System
Common Word System

| | | |
|---|---|---|
| Category 11 | Category 12 | . . . |

TABLE 8
Example of Substantive Word System
Substantive Word System

| | | |
|---|---|---|
| Category 21 | Category 22 | . . . |

When the unknown string is added to the first category as a first entry, the unknown string as the first entry is added to the system where the first category belongs (either in the common word system or the substantive word system). When the first category is a category in the common word system, the first entry can also be the seed word corresponding to the first category.

The mining layer can also decide based on characteristic marks whether the unknown strings are corresponding entries in the first category. Characteristic marks include, for example, brackets, comma, title marks and so forth, such as punctuation related to a given category. For example, when a category is movie or TV, the basic data processing layer may obtain a sentence having title marks, and the mining layer will match the corresponding index words in the movie category and the words in the sentence with title marks. If there is a successful match, then the words quoted with the title marks (i.e., an unknown string) become an entry under the movie (or TV) category. Words in parentheses are usually proper nouns in English (words before the parentheses), and words before and after a comma usually belong to the same category.

The data mining layer can also set properties for the first entry. In one embodiment, the data processing layer acquires a table from the webpage. The data mining layer make a given word a property of the first entry when such word appears in pair with the first entry multiple times in the table. For example, the first entry may be a product. It is usually in the form of tables listing the origin of products, manufacturers, size, model (or specifications). For example, there may be many kinds and many types of manufacturers, but the word “manufacturer” appears many times in pair with the first entry. In such case, the word “manufacturer” is made a property of the first entry.

The data mining layer analyzes categories one by one, and generates a respective result file for each category. This result file may include the category, corresponding entries of the category, and the weight of each entry of the category. Given that a knowledge base usually does not have only one category, through an integration layer, many results files may be combined into one result file.

The integration layer can filter the category of the corresponding entry. The data mining layer adds the unknown string to a category corresponding to a given representative word, due to the appearance of the unknown string together with the representative word. Error in filtering may occur if filtering is solely based on the frequency of an unknown string appearing together with a representative word. For example, there may be some uncommon words which may appear less frequently but are still correct. One the other hand, there may be some common words which appear more frequently but it may still be an error for such a common word to appear in certain sentences, possibly due to clerical error. As such problem may not be realized by the data mining layer, filtering by the integration layer is necessary. In one embodiment, the integration layer compares individual weights of a given entry in the various categories that correspond to the entry. If the comparison complies with certain conditions, then it is deemed correct that the entry is added to these categories. Otherwise, the correlation between the entry and a category to which the entry was incorrectly added to is canceled. There are many ways to conduct the comparison. In one embodiment, the largest weight and the smallest weight other than zero are compared; and if the ratio of the smallest weight to the largest weight is less than a first threshold, then the smallest weight is set to zero and the correlation between the respective entry and the category corresponding to the smallest weight is canceled. Alternatively, the smallest weight other than zero for a given entry is compared with the total weight of the entry (the sum of the weights of the entry), and if the ratio of the smallest non-zero weight to the total weight is less than a second threshold, then the smallest non-zero weight is set to zero and the correlation between the respective entry and the category corresponding to the smallest non-zero weight is canceled.

The knowledge base can be used in many fields. For example, a knowledge base can be used to analyze the intent of a user, to provide service to a search engine, in order to obtain better the search results. As another example, the knowledge base can provide prompts to a user by providing suggestive information to the user. Accordingly, in some embodiments, the knowledge base also includes an application layer, and conducting search is one way to utilize the application layer.

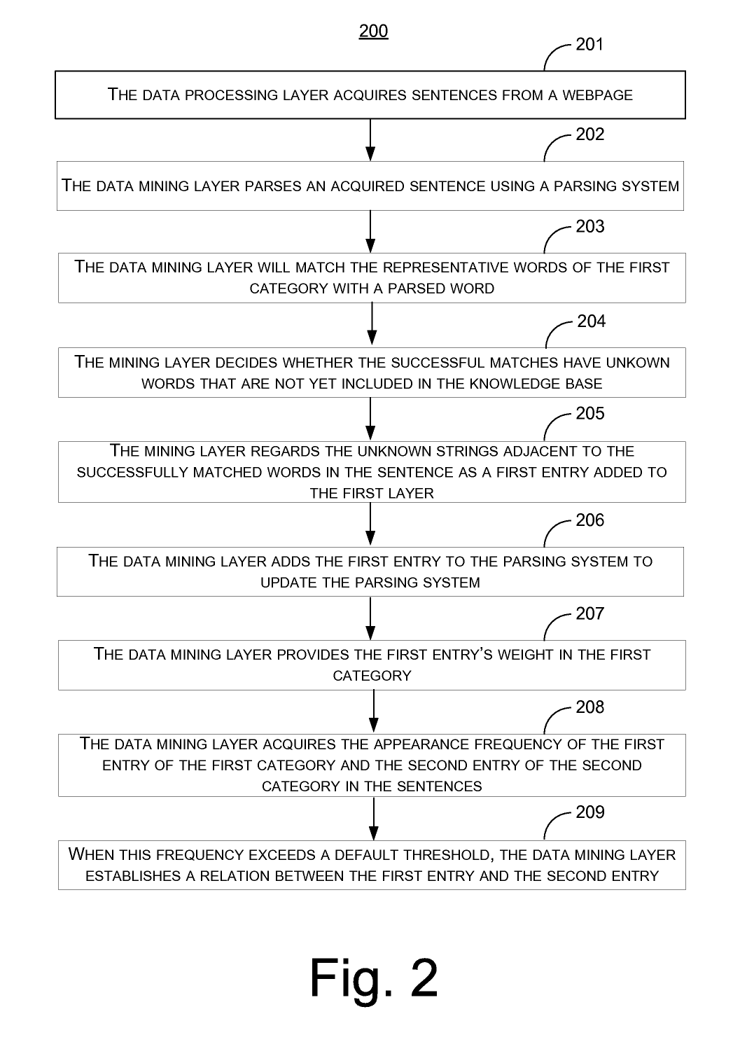

FIG. 3 illustrates a method 300 of searching information when analyzing a webpage's schema.

At 301, based on words parsed from a search term inputted by a user, the parsed words are compared to the search term to obtain a matched word, or label.

At 302, a webpage corresponding to the matched word is obtained.

At 303, the obtained webpage or a link to the obtained webpage is provided to the user. Here, the matched word, or label, is a new search word obtained based on one or more keywords of the webpage and entries of a knowledge base that are related to the one or more keywords.

The process of obtaining a label includes: extracting a keyword from the webpage, matching the keyword with entries in the knowledge base, obtaining a related entry that is related to a successfully matched entry, and obtaining the label based on the keyword and the related entry. A label obtained this way can more accurately reflect the content of the webpage, and thus through labels a user can obtain search results that are more satisfactory. For example, when a webpage content includes the phrase “selling N78 mobile phone”, and if the user enters the search term [symbol] (meaning “Nokia” in English), then most likely this webpage cannot be found under existing search techniques. This is because this webpage neither includes the term “Nokia” nor synonyms of “Nokia”. However, with the disclosed knowledge base and using the disclosed techniques, “N78” is a model of the brand “Nokia”, and therefore search results provided to a user may be more accurate when the user is indeed searching for the model N78 of Nokia mobile phone.

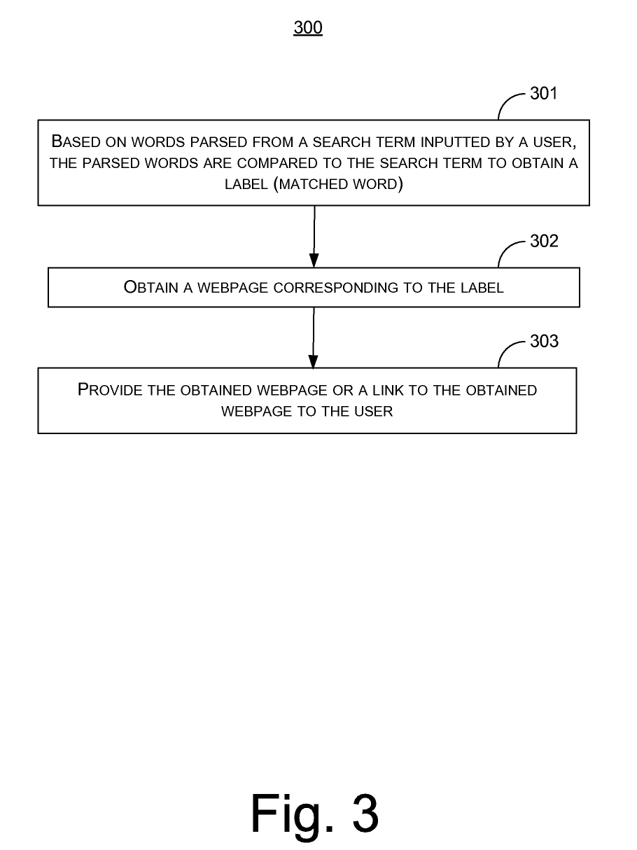

FIG. 4 illustrates a process 400 of searching information when analyzing a user's intent.

At 401, a search term inputted by a user is parsed based on entries in a knowledge base. In this case, the search term may be a sentence, words, or a phrase having many words. For example, the user may enter the search term [symbol] [symbol] BB1” (meaning “at what place can BB1 be purchased” in English). After parsing, the search term may be divided into the following words/phrases: [symbol] [symbol] , BB1 (meaning “at”, “what place”, “can”, “purchase” and “BB1” in English).

At 402, the words/phrases parsed from the search term are matched with entries of the knowledge base to identify the entry or entries with a successful match. For example, “purchase” is an entry under the “buy-sell” category, whereas “BB1” is an entry under the “model” category.

At 403, those entries that are related to the entry with a successful match are obtained, based on the knowledge base. For example, “BB1” is related to the entries “AA” and “mobile phone”, where “AA” corresponds to the “brand” category and “mobile phone” corresponds to the “product” category.

At 404, the search term is updated based on the related entries. For example, the updated search term may be “purchase AA brand mobile phone, model is BB1”, which more accurately reflects the user's intent.

At 405, keywords of the webpage and matched to the updated search term. In particular, the label as described with reference to FIG. 3 and the updated search term are matched, and a webpage corresponding to the successfully matched label is identified.

At 406, the identified webpage or a link to such webpage is provided, or presented, to the user as the search result, thereby accomplishing the information search. In one embodiment, the order in which webpages or links to the webpages are presented to the user may depend on the extent of successful matching between the label and keywords of each of the webpages. The webpage with the most matching categories and entries is considered to be the webpage with the most successful matching.

An entry may correspond to multiple categories. Take “apple” for example, it can be an entry under the “fruit” category, an entry under the “clothing” category, or even an entry under the “electronic product brand” category. Therefore, in the process of search term update and webpage update, additional search terms may be obtained based on the various categories. A search term that is closest to the intent of the user is to be identified from among the various updated search terms, and there are many ways to achieve this. For example, the entry with the largest weight corresponding to a category can be determined In the knowledge base, based on the entry corresponding to the category with the largest weight, entries related to a successfully matched entry are obtained. Moreover, based on these related entries, the search term inputted by the user is updated. Alternatively, words obtained after parsing and the representative words corresponding to the many categories are matched. Through the knowledge base and according to the categories corresponding to successfully-matched representative word(s), entries related to those entries corresponding to such categories can be obtained. The search term can be updated based on the obtained entries.

The disclosed knowledge base may be further able to provide prompts to the user when the user wants to disseminate information. For example, at a time when the user wants to release sale information related to mobile phones, prompts such as entries related to “mobile phone” and properties of the entry “mobile phone” may be provided, or presented, to the user when the user inputs “mobile phone” in the product field and after there is a successful match. Thereafter, the user can complete other input fields by clicking on the prompted information. As such, the operational process is simplified while the user experience is enhanced.

The above description allows one of ordinary skill in the art to understand how to contrast the disclosed knowledge base and how to accomplish information search using such knowledge base. The actual implementation can be carried out by an apparatus, and description of such an apparatus will be explained below.

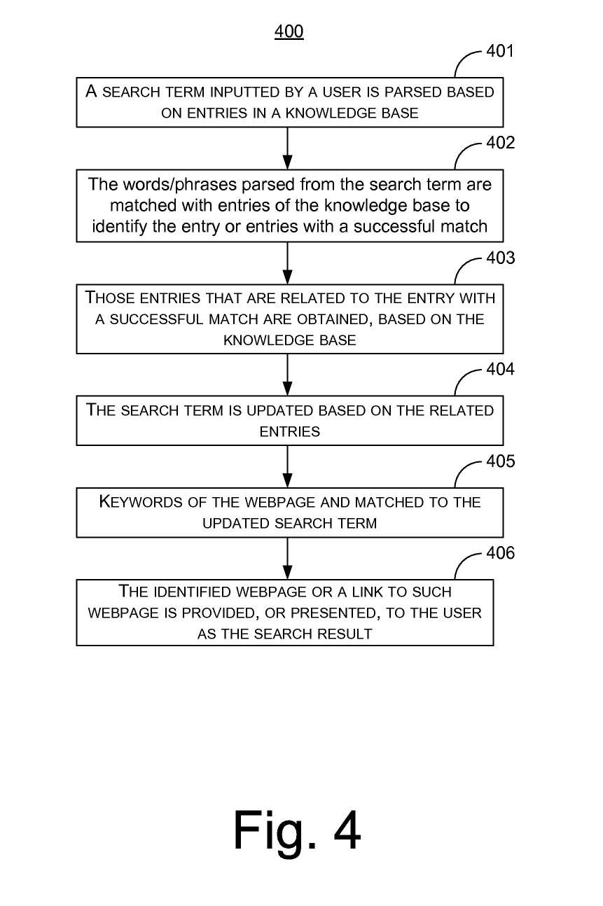

FIG. 5 illustrates a computing apparatus 500 according to one embodiment of the present disclosure. Every layer of a computing apparatus used to construct the disclosed knowledge base may be implemented with functional modules. Accordingly, the computing apparatus includes a basic data processing module 501 and a data mining module 502.

The basic data processing module 501, or the basic data processing layer of the computing apparatus 500, is used to obtain sentences from webpages.

The data mining module 502, or the data mining layer of the computing apparatus 500, is used to parse the obtained sentences. The data mining module 502 matches representative words corresponding to the first category of the knowledge base with the words obtained from parsing. If at least one of the parsed words is successfully matched, a string of unknown words and/or marks adjacent to the matched word in the sentence will be treated as a first entry and added to the first category. When a word in the sentence matches with a second entry of a second category, the data mining layer 502 determines whether or not there is existing correlation between the first and second categories. If a correlation exists, then a correlation between the first and second entries is established. The data mining module 502 can also establish property/properties for an entry, as well generate a result file for each category.

The computing apparatus 500 further comprises an integration module 503 (i.e., integration layer) and a utilization module 504 (i.e., utilization layer). The integration module 503 integrates resulting files from the data mining module 502 into one result file, and filters categories corresponding to an entry.

The utilization module 504 provides various sorts of applications. A search engine is one of the application units of the utilization module 504.

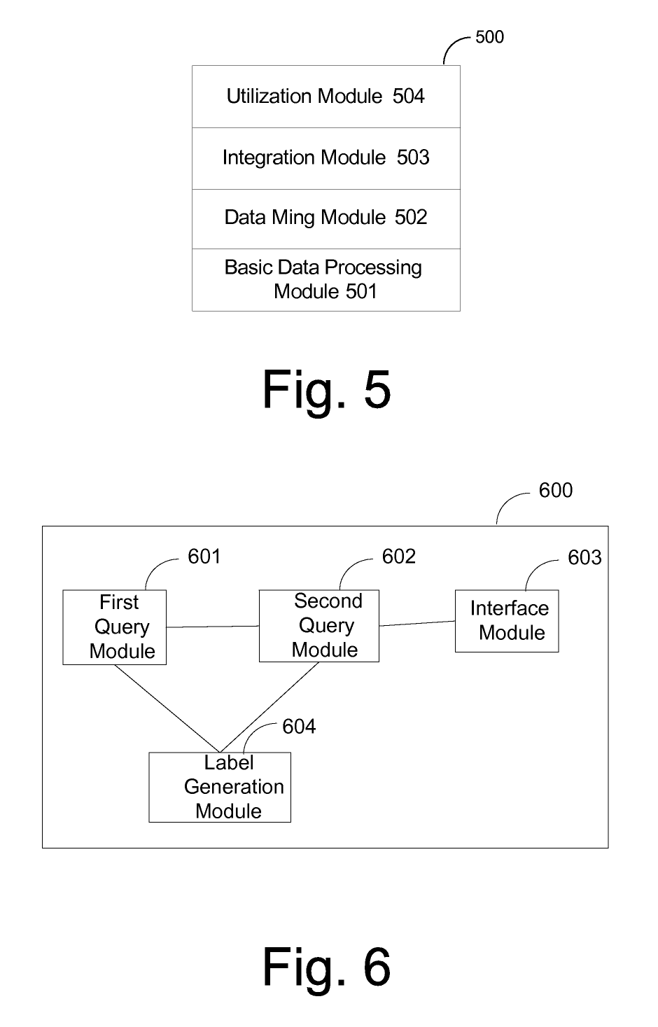

FIG. 6 illustrates a search engine 600 according to one embodiment of the present disclosure. The search engine 600 includes a first query module 601, a second query module 602, an interface module 603, and a label generation module 604.

The first query module 601 obtains a label corresponding to a search term inputted by a user. The second query module 602 obtains a webpage corresponding to the label. The interface module 603 provides to the user the webpage or a link to the webpage. The label generation module 604 generates labels corresponding to the webpage based on one or more keywords of the webpage and entries of a knowledge base that are related to the one or more keywords.

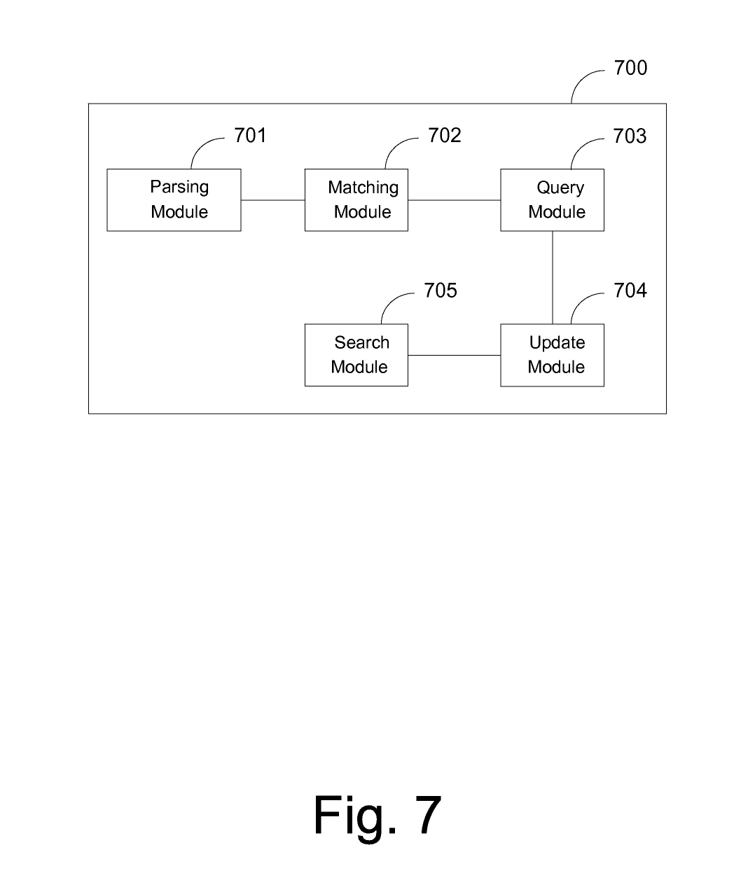

FIG. 7 illustrates a search engine 700 according to another embodiment of the present disclosure. The search engine 700 includes a parsing module 701, a matching module 702, a query module 703, an update module 704, and a search module 705.

The parsing module 701 parses a search term inputted by a user based on entries of a knowledge base. The matching module 702 matches words parsed from the search term with the entries of the knowledge base. The query module 703 identifies those entries of the knowledge base that are related to an entry having a match with a word parsed from the search term. The update module 704 updates the search term with those entries of the knowledge base that are related to the entry having a match with a word parsed from the search term. The search module 705 conducts a search based on the updated search term. Additionally, the search module 705 matches the sentences of the webpage with updated keywords, and provides a user with the webpage or a link to the webpage that has a successful match with a keyword. In one embodiment, when there are multiple webpages with successful match, the search module 705 may provide the user with the webpages with matches, or links to such webpages, in a descending order, e.g., from the webpage with the most successful matches to the webpage with the least successful matches.

The search engine 600 and the search engine 700 may each be a part of a single search engine, which includes the features and functionality of those shown in FIGS. 6 and 7. The first query module 601 and the second query module 602 are equivalent to the search module 705, which, based on an updated search term, acquires a label corresponding to the updated search term to search the webpage. The search engine 700 may also include the interface module 603, which receives from a user the search term and provides to the user the webpage(s) or link(s) to the webpage(s) identified from a search.

For the sake of convenience of description, features and functions of an exemplary computing apparatus or search engine are described as the various modules. Of course, in various embodiments, features and functions of any module described herein may be implemented in one or more instances of software or hardware.

The disclosed computing apparatus, search engine, and their modules may be implemented using software and/or hardware. When implemented with software, the software may be stored in one or more computer-readable media such as floppy disks, hard disks, CD-ROM, and flash memory. The disclosed methods, knowledge base, and search engine may be implemented in one or more networked computers of a network system.

The implementation of the present disclosure will match the words in the sentences and the marked words in the knowledge base. Based on the successfully matched words, the category in the knowledge base to which the unknown words are determined and regarded as the entry under that category. And based on the correlations within the category, a correlation is built among the entries appearing in the sentence, in order to update the knowledge base. The implementation of the present disclosure also sets the weight of the unknown word under the corresponding category based on the frequency of appearance of the unknown word and the successfully matched marked word. It also sets the properties of the unknown words through the appearance of the unknown words in the webpage's form, in order to provide more information for each field in knowledge base. At the same time, the implementation of the present disclosure is used for updating the search word inputted by the user through knowledge base, in order to be more accurate towards the user's intention. And it searches based on the updated search term, in order to have more accurate search results. And, the implementation sets the tags of the main theme for the webpage through the knowledge base so as to for the webpage to more accurately express the intention of the user. It will also match the tags and the updated search word to achieve more accurate search result.

Of course, a person of ordinary skill in the art can alter or modify the present disclosure in many different ways without departing from the spirit and the scope of this disclosure. Accordingly, it is intended that the present disclosure covers all modifications and variation which falls within the scope of the claims of the present disclosure and their equivalent.

What is claimed is:

1. A method of knowledge base building using a computing apparatus, the method comprising:
acquiring a sentence from a webpage using a basic data processing layer of the computing apparatus;
parsing the acquired sentence into words using a data mining layer of the computing apparatus;
matching one or more representative words in a first category of a knowledge base with the words parsed from the acquired sentence;
when there is a match between one of the representative words and one of the words parsed from the acquired sentence, adding a string of words adjacent the matched word in the acquired sentence to the first category as a first entry;
when matching the words parsed from the acquired sentence with a second entry of a second category of the knowledge base, determining whether or not an established correlation exists between the first category and the second category; and
when it is determined that an established correlation exists between the first category and the second category, establishing a correlation between the first entry of the first category and the second entry of the second category.

2. The method as recited in claim 1, wherein acquiring a sentence from a webpage comprises dividing the acquired sentence into multiple shorter sentences based on punctuation marks in the acquired sentence, and wherein parsing the acquired sentence comprises parsing the acquired sentece or parsing the multiple shorter sentences.

3. The method as recited in claim 1, further comprising:
the basic data processing layer counting a number of appearances of individual sentences; and
the data mining layer establishing a weighted value of the first entry of the first category based on a number of appearances of any sentence having the first entry and one or more of the representative words adjacent the first entry.

4. The method as recited in claim 1, wherein the data mining layer employs a parsing system that includes the one or more representative words to divide the acquired sentence.

5. The method as recited in claim 1, wherein the knowledge base includes a common word system and a substantive word system, wherein the common word system and the substantive word system respectively include different categories, wherein the representative words include category-corresponding index words of the substantive word system and category-corresponding seed words of the common word system, and wherein when the string of words adjacent the matched word in the acquired sentence is added to the first category as the first entry, the string of words is added to the common word system or the substantive word system that includes the first category.

6. The method as recited in claim 5, wherein when the first category is one of the categories included in the common word system, the method further comprises:
setting the first entry as the seed word corresponding to the first category.

7. The method as recited in claim 1, wherein establishing a correlation between the first entry of the first category and the second entry of the second category comprises:
obtaining a frequency of appearance of sentences of the first entry and the second entry; and
establishing the correlation between the first and second entry when the frequency of appearance of sentences of the first entry and the second entry exceeds a predetermined threshold value.

8. The method as recited in claim 1, further comprising:
the data mining layer generating a respective result file according to each category and respective entries under each category; and
an integration layer of the computing apparatus integrating multiple result files into a single result file.

9. The method as recited in claim 8, further comprising:
counting a number of appearances of individual sentences;
establishing a weighted value of the first entry of the first category based on a number of appearances of any sentence having one or more of the representative words and the first entry;
comparing weighted values of individual entries under different categories; and
filtering entry-corresponding categories.

10. The method as recited in claim 1, further comprising:
acquiring a table from the webpage; and
attributing a word that appears in the table in a pair with the first entry multiple times as a property of the first entry.

11. The method as recited in claim 1, wherein acquiring a sentence from a webpage comprises acquiring from the webpage a sentence that contains special symbols.

12. A method of information searching, the method comprising:
Identifying, in a knowledge base, a label based on one or more keywords in a webpage and entries related to the one or more keywords, the label matching a search term inputted by a user;
locating the webpage that corresponds to the label; and
providing to the user the webpage or a link to the webpage.

13. The method as recited in claim 12, wherein the knowledge base is constructed by:
acquiring a sentence from one of a plurality of webpages using a basic data processing layer of a computing apparatus;
parsing the acquired sentence into words using a data mining layer of the computing apparatus;
matching one or more representative words in a first category of the knowledge base with the words parsed from the acquired sentence;
when there is a match between one of the representative words and one of the words parsed from the acquired sentence, adding a string of words adjacent the matched word in the acquired sentence to the first category as a first entry;
when matching the words parsed from the acquired sentence with a second entry of a second category of the knowledge base, determining whether or not an established correlation exists between the first category and the second category; and
when it is determined that an established correlation exists between the first category and the second category, establishing a correlation between the first entry of the first category and the second entry of the second category.

14. A method of information searching, the method comprising:
parsing a search term inputted by a user using entries of a knowledge base;
matching words parsed from the search term with the entries of the knowledge base;
identifying those entries of the knowledge base that are related to an entry having a match with a word parsed from the search term;
updating the search term with those entries of the knowledge base that are related to the entry having a match with a word parsed from the search term; and
conducting a search based on the updated search term.

15. The method as recited in claim 14, wherein the knowledge base is constructed by:
acquiring a sentence from a webpage using a basic data processing layer of a computing apparatus;
parsing the acquired sentence into words using a data mining layer of the computing apparatus;
matching one or more representative words in a first category of the knowledge base with the words parsed from the acquired sentence;
when there is a match between one of the representative words and one of the words parsed from the acquired sentence, adding a string of words adjacent the matched word in the acquired sentence to the first category as a first entry;
when matching the words parsed from the acquired sentence with a second entry of a second category of the knowledge base, determining whether or not an established correlation exists between the first category and the second category; and
when it is determined that an established correlation exists between the first category and the second category, establishing a correlation between the first entry of the first category and the second entry of the second category.

16. A computing apparatus that constructs a knowledge base, the computing apparatus comprising:
a basic data processing module that acquires one or more sentences from a webpage; and
a data mining module that parses the one or more sentences acquired from the webpage, the data mining module further:
matching one or more representative words in a first category of the knowledge base with the words parsed from the acquired sentence;
when there is a match between one of the representative words and one of the words parsed from the acquired sentence, adding a string of words adjacent the matched word in the acquired sentence to the first category as a first entry;
when matching the words parsed from the acquired sentence with a second entry of a second category of the knowledge base, determining whether or not an established correlation exists between the first category and the second category; and
when it is determined that an established correlation exists between the first category and the second category, establishing a correlation between the first entry of the first category and the second entry of the second category.

17. A search engine, comprising:
a first query module that identifies a label corresponding to a search term inputted by a user;
a second query module that identifies a webpage corresponding to the label;
an interface module that provides to the user the webpage or a link to the webpage; and
a label generation module that generates labels corresponding to the webpage based on one or more keywords of the webpage and entries of a knowledge base that are related to the one or more keywords.

18. A search engine, comprising:
a parsing module that parses a user-inputted search term into words based on entries of a knowledge base;
a matching module that matches words parsed from the search term with the entries of the knowledge base;
a query module that identifies those entries of the knowledge base that are related to an entry having a match with a word parsed from the search term;
an update module that updates the search term with those entries of the knowledge base that are related to the entry having a match with a word parsed from the search term; and
a search module that conducts a search based on the updated search term.
